(19) United States
(12) Patent Application Publication
(10) Pub. No.: US 2025/0208577 A1
(43) Pub. Date: Jun. 26, 2025

(54) HAND-SETTING DEVICE FOR A HOROLOGICAL MOVEMENT

(71) Applicant: Montres Breguet S.A., L'Abbaye (CH)

(72) Inventors: Daniel MATTEAZZI, Le Sentier (CH); Grégory GAUTHIER, Saint-Cergue (CH)

(73) Assignee: Montres Breguet S.A., L'Abbaye (CH)

(21) Appl. No.: 18/950,360

(22) Filed: Nov. 18, 2024

(30) Foreign Application Priority Data
Dec. 22, 2023 (EP) 23219879.6

(51) Int. Cl. G04B 27/04

(52) U.S. Cl. CPC G04B 27/04

(57) ABSTRACT

A hand-setting device for a watch, which device includes a winding stem configured to occupy a hand-setting position in which it is engaged with a hand-setting gear train kinematically connected to a time display and to a 24-hour wheel, the 24-hour wheel being engaged with a barrel for providing energy for displaying a time value, the barrel including a click mechanism configured so as to permit rotation of the barrel through more than one revolution when the winding stem is rotated in a first direction, and so as to limit rotation of the barrel to an angular amplitude corresponding to less than one revolution when the winding stem is rotated in a second direction.

### TECHNICAL FIELD OF THE INVENTION

The invention relates to the field of watchmaking and relates in particular to a hand-setting device for a watch.

### TECHNOLOGICAL BACKGROUND

Watch hand-setting devices are integrated into the horological movement of the watch and are well known to a person skilled in the art.

For example, one commonly used hand-setting device comprises one or more intermediate wheels kinematically connecting a winding stem intended to be operated by a user to a minute wheel set connected to a time display.

When the horological movement includes one or more horological complications, the hand-setting device can be designed to comply with a number of constraints.

The present invention fits into this context. In particular, the present invention aims to eliminate any risk of damage to the horological movement when the watch hands are being set.

### SUMMARY OF THE INVENTION

To this end, the invention relates to a hand-setting device for a watch, comprising a winding stem configured to occupy a hand-setting position in which it is engaged with a hand-setting gear train kinematically connected to a time display and to a 24-hour wheel. The 24-hour wheel is engaged with a barrel comprising a mainspring for providing energy for displaying a time value, the barrel comprising a click mechanism configured so as to permit rotation of the barrel through more than one revolution when the winding stem is rotated in a first direction, and so as to limit rotation of the barrel to an angular amplitude corresponding to less than one revolution when the winding stem is rotated in a second direction.

In particular embodiments, the invention can further include one or more of the following features, which must be considered singly or according to any combination technically possible.

In particular embodiments, the hand-setting gear train comprises a friction wheel set configured to prevent motion from being transmitted from the winding stem to the 24-hour wheel when said winding stem is rotated in the second direction and the barrel is forced into a stop position by the click mechanism.

In particular embodiments, the hand-setting gear train comprises a transmission wheel set kinematically interposed between the friction wheel set and the time display.

In particular embodiments, the transmission wheel set is in meshing relationship with the 24-hour wheel and an hour wheel.

In particular embodiments, the barrel is configured so that the mainspring is preloaded when the winding stem is rotated in the second direction and when the click mechanism prevents rotation of the barrel.

In particular embodiments, the click mechanism comprises a protrusion eccentrically arranged on the barrel and extending parallel to the axis of rotation of the barrel, and a lever intended to cooperate with the protrusion so as to pivot the lever when the winding stem is rotated in the first direction, and so as to rest in abutment against said lever when the winding stem is rotated in the second direction.

In particular embodiments, the friction wheel set comprises two wheels, each arranged at one end of an arbor comprising a platform, one of the wheels, referred to as the “first wheel”, having a pipe applying a deformation force to a resilient member so as to force the latter to apply pressure to a flange so that the flange, in combination with the platform, applies clamping forces to the other wheel, referred to as the “second wheel”.

In particular embodiments, the resilient member consists of a part that is flat in a rest state and curved in a stressed state.

In particular embodiments, the resilient member is formed by a disc having radial lobes on its periphery, which lobes are intended to rest against the flange so as to rigidly attach said flange to the resilient member such that they rotate as one.

### BRIEF DESCRIPTION OF THE FIGURES

Other features and advantages of the invention will become apparent from the following detailed description, which is given by way of example and is by no means limiting, with reference to the accompanying drawings in which:

FIG. 1 shows a perspective view of the kinematic chain of the hand-setting device according to a preferred example embodiment of the invention;

FIG. 2 shows a cross-sectional view of a friction wheel set of a hand-setting device shown in FIG. 1;

FIG. 3 shows a perspective bottom view of the kinematic chain of the hand-setting device shown in FIG. 1.

It should be noted that the figures are not necessarily drawn to scale for reasons of clarity.

### DETAILED DESCRIPTION OF THE INVENTION

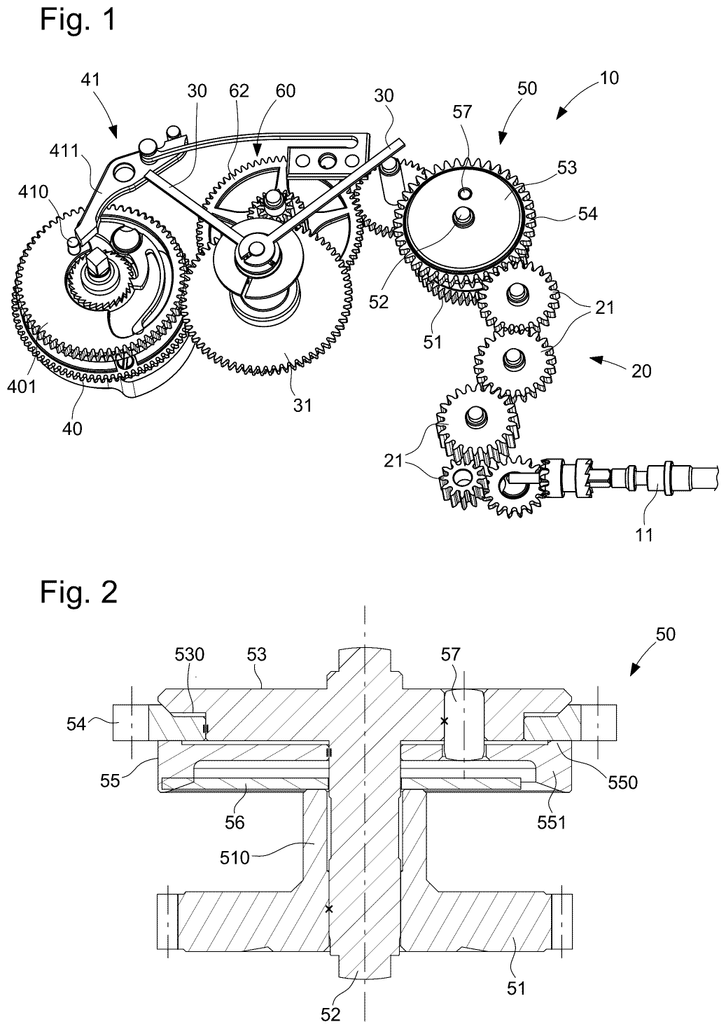

FIG. 1 shows a hand-setting device 10 for a watch, which device is intended to be integrated into a horological movement of said watch. In the preferred example embodiment of the invention shown in the figures and described in this text, the hand-setting device 10 is capable of setting both the time and the date of the watch.

The hand-setting device 10 comprises a winding stem 11 which a user of the watch is intended to operate in order to set the time and optionally the date. In particular, the winding stem 11 is configured to occupy a hand-setting position in which it engages with a hand-setting gear train 20 kinematically connected to a time display 30 and to a 24-hour wheel 31. The time display 30 consists of hour and minute hands in the preferred example embodiment of the invention.

The 24-hour wheel 31 is meshed with a barrel 40 comprising a mainspring 40 intended to supply the energy required to display a time value, in particular the date. In particular, the 24-hour wheel 31 is meshed with a ratchet 401 of the barrel 40. The barrel 40 can be as described in European patent EP3540524. The horological movement can comprise another barrel intended to supply the energy required to rotate the time display 30.

The barrel 40 comprises a click mechanism 41 configured so as to allow the barrel 40 to rotate over an angular amplitude corresponding to more than one revolution when the winding stem 11 is rotated in a first direction, and so as to limit rotation of the barrel 40 to an angular amplitude corresponding to less than one revolution when the winding stem 11 is rotated in a second direction.

Thanks to the features of the invention, the user can set the hands by moving the time display 30 in both directions of rotation, while avoiding completely unloading the mainspring 40. More specifically, setting the hands in the first direction has the effect of winding up the mainspring 40. Setting the hands in the second direction thus unloads the mainspring 40, until the click mechanism 41 locks it against rotation. It should be noted that when the click mechanism 41 locks the barrel 40 against rotation, the time display 30 is also immobilised.

In the preferred example embodiment of the invention, the click mechanism 41 comprises a protrusion 410, for example formed by a pin, arranged eccentrically on the barrel 40 and extending parallel to the axis of rotation of the barrel 40. Thus, when the barrel 40 rotates, the protrusion 410 is driven along a circular path centred about the axis of rotation of the barrel 40.

The click mechanism 41 further comprises a lever 411, one end of which is arranged in the path of the protrusion 410, so that when the barrel 40 is rotated, the protrusion 410 cooperates with the lever 411. More specifically, the protrusion 410 causes the lever 411 to pivot when the winding stem 11 is rotated in the first direction, and rests in abutment against said lever 411 when the winding stem 11 is rotated in the second direction. The latter case is shown in FIG. 1.

When the barrel 40 is locked against rotation by the click mechanism 41, i.e. when the protrusion 410 is arranged in abutment against the lever 411, a friction wheel set 50 advantageously makes it possible to avoid any damage to the horological movement, and in particular to a component of the kinematic chain of the hand-setting device 10. In particular, such damage is likely to occur if the winding stem 11 is driven rotatably in a second direction when the barrel 40 is locked against rotation.

As illustrated in FIG. 1, the friction wheel set 50 is arranged in the hand-setting gear train 20 and is configured to prevent motion from being transmitted from the winding stem 11 to the 24-hour wheel 31, when said winding stem 11 is rotated in the second direction and when the barrel 40 is forced into a stop position by the click mechanism 41.

In a preferred example embodiment of the invention, the friction wheel set 50, visible in a cross-sectional view in FIG. 2, comprises a driven wheel 51 linked without any degree of freedom to one end of an arbor 52, the arbor 52 comprising a platform 53 at its other end. The driven wheel 51 has a pipe 510 extending towards the platform 53. The platform 53 preferably has an annular shoulder 530 in which is housed a driving wheel 54 mounted so as to rotate freely relative to said platform 53. The driving wheel 54 is in a meshing relationship with one of the intermediate wheels 21, as can be seen in FIG. 1.

The friction wheel set 50 further comprises a flange 55 which is rotatably unmoving relative to the arbor 52 and which comprises an upper annular lip 550 facing the driving wheel 54 and against which it rests, and a lower annular lip 551 extending axially and facing the driven wheel 51. A resilient member 56 is interposed between the flange 55 and the driven wheel 51, through which resilient member the arbor 52 extends and which is stressed by the lower annular lip 551 and the pipe 510.

In the preferred example embodiment of the invention, the resilient member 56 consists of a part that is flat in a rest state and curved in a stressed state. The resilient member is, for example, formed by a disc having radial lobes on its periphery, said lobes being intended to rest against the lower annular lip 551. The fact that the resilient member 56 is formed by a part that is flat in a rest state in particular makes it easier to manufacture and guarantees compliance with manufacturing tolerances. Advantageously, the lobes allow the mechanical stresses to be distributed evenly. To facilitate assembly of the friction wheel set 50, a pin 57 can be engaged in corresponding holes in the platform 53 and in the flange 55 so as to ensure that they rotate as one.

The resilient member 56 is stressed in order to apply pressure to the lower annular lip 551 of the flange 55, causing the driving wheel 54 to be clamped between the upper annular lip 550 of the flange 55 and the platform 53. The driving wheel 54 thus transmits a rotational motion to the driven wheel 51, up to a certain friction torque beyond which the upper annular lip 550 and the platform 53 slide against the driving wheel 54. Such a friction torque is produced when the barrel 40 is locked against rotation by the click mechanism 41 and when the winding stem 11 is rotated in the second direction.

The stressing of the resilient member 56, and in particular of the disc with radial lobes, allows the friction torque to be controlled and facilitates the manufacture and assembly of the friction wheel set 50.

Moreover, the interface surfaces of the platform 53 and of the driving wheel 54 advantageously have a bevelled cross-section, as does the interface surface of the lower annular lip 551 intended to receive the resilient member 56 in abutment. The particular arrangement of these surfaces allows greater control of the friction torque.

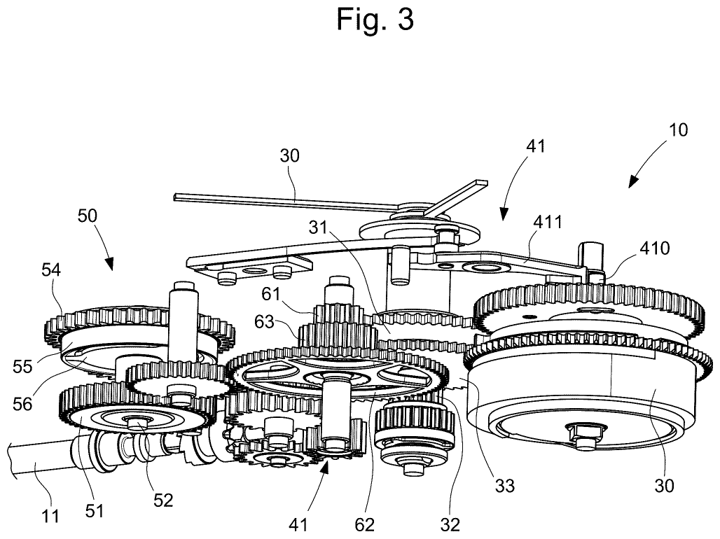

As can be seen in FIGS. 1 and 3, the hand-setting gear train 20 comprises a plurality of intermediate wheels 21 allowing the winding stem 11 and the friction wheel set 50 to be kinematically connected to one another. The hand-setting gear train 20 further includes a transmission wheel set 60 kinematically interposed between the friction wheel set 50 and the time display 30. The transmission wheel set 60 is in a meshing relationship with the driven wheel 51, for example by means of an intermediate wheel, as can be seen in FIG. 1.

As shown in FIG. 3, the transmission wheel set 60 is in a meshing relationship with the 24-hour wheel 31, a cannon-pinion 32 and an hour wheel 33, respectively via a 24-hour pinion 61, a minute wheel 62 and a minute pinion 63.

The barrel 40 is configured so that the mainspring 40 is preloaded when the winding stem 11 is rotated in the second direction and when the click mechanism 41 prevents rotation of the barrel 40. This feature prevents the mainspring 40 from being completely let down, and thus conserves a certain amount of energy in the barrel 40. In particular, this preloading makes it possible to control the angular position of the barrel 40.

More generally, it should be noted that the implementations and embodiments considered above have been described by way of non-limiting examples, and that other alternatives are thus possible.

In particular, in other example embodiments of the invention, the driven wheel 51 and the driving wheel 54 can be reversed without changing the operation of the friction wheel set 50. In other words, the wheel referred to as the “driven wheel 51” in this text and as shown in FIG. 2 could be driving and the wheel referred to as the “driving wheel 54” could be driven.

1. A hand-setting device for a watch, wherein the device comprises a winding stem configured to occupy a hand-setting position in which it is engaged with a hand-setting gear train kinematically connected to a time display and to a 24-hour wheel, the 24-hour wheel being engaged with a barrel comprising a mainspring for providing energy for displaying a time value, the barrel comprising a click mechanism configured so as to permit rotation of the barrel through more than one revolution when the winding stem is rotated in a first direction, and so as to limit rotation of the barrel to an angular amplitude corresponding to less than one revolution when the winding stem is rotated in a second direction.

2. The device according to claim 1, wherein the hand-setting gear train comprises a friction wheel set configured to prevent motion from being transmitted from the winding stem to the 24-hour wheel when said winding stem is rotated in the second direction and when the barrel is forced into a stop position by the click mechanism.

3. The device according to claim 2, wherein the hand-setting gear train comprises a transmission wheel set kinematically interposed between the friction wheel set and the time display.

4. The device according to claim 3, wherein the transmission wheel set is in a meshing relationship with the 24-hour wheel and an hour wheel.

5. The device according to claim 1, wherein the barrel is configured so that the mainspring is preloaded when the winding stem is rotated in the second direction and when the click mechanism prevents rotation of the barrel.

6. The device according to claim 1, wherein the click mechanism comprises a protrusion eccentrically arranged on the barrel and extending parallel to the axis of rotation of the barrel, and a lever intended to cooperate with the protrusion so as to pivot the lever when the winding stem is rotated in the first direction, and so as to rest in abutment against said lever when the winding stem is rotated in the second direction.

7. The device according to claim 2, wherein the friction wheel set comprises two wheels, each arranged at one end of an arbor comprising a platform, one of the wheels, referred to as the “first wheel”, having a pipe applying a deformation force to a resilient member so as to force the latter to apply pressure to a flange so that the flange, in combination with the platform, applies clamping forces to the other wheel, referred to as the “second wheel”.

8. The device according to claim 7, wherein the resilient member consists of a part that is flat in a rest state and curved in a stressed state.

9. The device according to claim 8, wherein the resilient member is formed by a disc having radial lobes on its periphery, which lobes are intended to rest against the flange so as to rigidly attach said flange to the resilient member such that they rotate as one.
